(19) United States
(12) Patent Application Publication
(10) Pub. No.: US 2021/0093029 A1
(43) Pub. Date: Apr. 1, 2021

(54) Waterproof Garment With Exterior Hydrostatic Barrier

(71) Applicant: Cohesive Systems LLC, Mechanicsville, PA (US)

(72) Inventor: Joseph E. GALLAGHER, Mechanicsville, PA (US)

(21) Appl. No.: 16/499,554

(22) PCT Filed: Mar. 30, 2018
(86) PCT No.: PCT/US2018/025344

§ 371 Date: Sep. 30, 2019

Related U.S. Application Data
(60) Provisional application No. 62/478,739, filed on Mar. 30, 2017.

(51) Int. Cl. A41D 27/24; B29C 65/50; B29C 65/08

(52) U.S. Cl. CPC A41D 27/245; B29L 2031/4842; B29C 65/08; B29C 65/5057

(57) ABSTRACT

Various fabric products incorporating exterior hydrostatic barriers and processes for manufacturing such fabric products are provided.

### CROSS REFERENCE TO RELATED APPLICATIONS

This application claims priority under 35 U.S.C. § 119(e) of U.S. Provisional Application No. 62/478,739, filed on Mar. 30, 2017, entitled “Waterproof Garment with Exterior Hydrostatic Barrier,” the disclosure of which is hereby incorporated by reference.

### STATEMENT REGARDING FEDERALLY SPONSORED RESEARCH OR DEVELOPMENT

N/A

### BACKGROUND

The availability of waterproof or water resistant fabrics for outerwear garments and other fabric products presents challenges to create seams that share the water shedding characteristics of the fabrics. The challenge can be particularly great in fabric products in which a hydrostatic barrier material is provided on an exterior surface of the product.

### SUMMARY

Various aspects of fabric products incorporating exterior hydrostatic barriers and processes for manufacturing such fabric products are provided. Aspects of the products and processes include the following:

1. A fabric garment comprising:

a body panel and two sleeve panels, each of the body panels and the two sleeve panels comprising an outer hydrophobic polymer membrane and an inner textile layer fused together over their surfaces;

wherein the two sleeve panels are joined to the body panel along sleeve seams, and the body panel includes a shoulder seam at each sleeve seam;

wherein each of the sleeve seams and the shoulder seams comprises an outer seam comprising joined edge portions of adjacent panels of the hydrophobic polymer membrane and an inner seam comprising joined edge portions of adjacent panels of the inner textile layer, the outer seam and the inner seam adhesively sealed in alignment to form a hydrophobic barrier seam.

2. The fabric garment of embodiment 1, wherein the body panel comprises a single continuous panel.
3. The fabric garment of any of embodiments 1-2, wherein the body panel has no side seams adjacent the sleeve panels.
4. The fabric garment of any of embodiments 1-3, wherein the body panel extends continuously from one side of a front opening to another side of a front opening.
5. The fabric garment of any of embodiments 1-4, wherein the outer seam is joined by ultrasonic welding.
6. The fabric garment of any of embodiments 1-5, wherein the edge portions of the outer seam are overlapping.
7. The fabric garment of any of embodiments 1-6, wherein the hydrophobic polymer membrane is not punctured or sewn along the outer seam.
8. The fabric garment of any of embodiments 1-7, wherein the inner seam is joined by ultrasonic welding or sewing.
9. The fabric garment of any of embodiments 1-8, wherein the edge portions of the inner seam are overlapping.
10. The fabric garment of any of embodiments 1-9, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.
11. The fabric garment of 1-10, further comprising an adhesive layer between the outer hydrophobic polymer membrane and the inner textile layer.
12. The fabric garment of embodiment 11, wherein the adhesive layer is prepared from a powder adhesive, a web adhesive, a micro dot adhesive, or a nano dot adhesive.
13. The fabric garment of any of embodiments 1-12, further comprising a polymer layer coating disposed on an external surface of the hydrophobic polymer membrane.
14. The fabric garment of embodiment 13, wherein the polymer coating provides abrasion resistance.
15. The fabric garment of any of embodiments 1-14, further comprising a middle textile layer comprising two middle textile panels joined at a middle seam, the middle seam comprising joined edge portions of each of the two middle textile panels, wherein the middle textile layer is disposed between the membrane and the inner textile layer and the middle seam is disposed between and adhesively sealed in alignment with the outer seam and the inner seam.
16. The fabric garment of embodiment 15, wherein the middle textile layer comprises one or more cut away regions through which the inner textile layer is visible through the outer polymer membrane.
17. The fabric garment of any of embodiments 15-16, wherein the middle textile layer comprises a garment shell fabric.
18. The fabric garment of any of embodiments 1-17, wherein the inner textile layer comprises a garment shell fabric or a garment lining fabric.
19. The fabric garment of any of embodiments 1-18, further comprising a seam tape adhered between the inner seam and the outer seam within the hydrophobic barrier seam structure, the seam tape comprising a further hydrophobic polymer membrane layer and an adhesive layer on one or both sides of the further hydrophobic polymer membrane layer.
20. The fabric garment of any of embodiments 1-19, further comprising one or more of a collar, a hood, a zipper, a pocket, or findings.
21. A process for fabricating a garment comprising:

(a) providing fabric panels of at least an inner textile layer comprising a body panel and two sleeve panels;

(b) providing membrane panels of at least a hydrophobic polymer membrane corresponding to the body panel and the two sleeve panels;

(c) aligning each membrane panel to a corresponding fabric panel with the hydrophobic polymer membrane on an exterior surface of the inner textile layer, each membrane panel and each corresponding fabric panel laid out flat to form a plurality of composite fabric panels;

(d) fusing each of the composite panels together, leaving an area about a perimeter of each composite fabric panel unfused;

(e) joining the composite panels together at sleeve seams and shoulder seams, each sleeve seam and shoulder seam comprising an outer seam comprising joined edge portions of adjacent panels of the hydrophobic polymer membrane and an inner seam comprising joined edge portions of adjacent panels of the inner textile layer, the outer seam and the inner seam adhesively sealed in alignment to form a hydrophobic barrier seam.

22. The process of embodiment 21, wherein the body panel extends continuously from one side of a front opening to another side of a front opening.
23. The process of any of embodiments 21-22, wherein the body panel has no side seams.
24. The process of any of embodiments 21-23, wherein the body panel is a single continuous panel.
25. The process of any of embodiments 21-24, wherein in step (e), joining the outer seam by ultrasonic welding.
26. The process of any of embodiments 21-25, wherein in step (e), the edge portions of the outer seam are overlapping.
27. The process of any of embodiments 21-26, wherein in step (e), the hydrophobic polymer membrane is not punctured or sewn along the outer seam.
28. The process of any of embodiments 21-27, wherein in step (e), joining the inner seam by ultrasonic welding or sewing.
29. The process of any of embodiments 21-28, wherein in step (e), the edge portions of the inner seam are overlapping.
30. The process of any of embodiments 21-29, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.
31. The process of any of embodiments 21-30, further comprising an adhesive between the outer hydrophobic polymer membrane and the inner textile layer.
32. The process of embodiment 31, wherein the adhesive is prepared from a powder adhesive, a web adhesive, a micro dot adhesive, or a nano dot adhesive.
33. The process of any of embodiments 21-32, wherein the membrane panel further includes a polymer layer coating disposed on an external surface of the hydrophobic polymer membrane.
34. The process of embodiment 33, wherein the polymer layer coating provides abrasion resistance.
35. The process of any of embodiments 33-34, wherein the membrane panel further includes a tricot layer disposed between the hydrophobic polymer membrane and the polymer layer coating.
36. The process of any of embodiments 21-35, further comprising joining two middle textile panels at a middle seam to form a middle textile layer, the middle seam comprising joined edge portions of each of the two middle textile panels, wherein the middle textile layer is disposed between the membrane and the inner textile layer and the middle seam is disposed between and adhesively sealed in alignment with the outer seam and the inner seam.
37. The process of embodiment 36, wherein the middle textile layer comprises one or more cut away regions through which the inner textile layer is visible through the outer polymer membrane.
38. The process of any of embodiments 36-37, wherein the middle textile layer comprises a garment shell fabric.
39. The process of any of embodiments 21-38, wherein the inner textile layer comprises a garment shell fabric or a garment lining fabric.
40. The process of any of embodiments 21-39, further comprising, in step (e), inserting a seam tape between the inner seam and the outer seam within the hydrophobic barrier seam structure, the seam tape comprising a further hydrophobic polymer membrane layer and an adhesive layer on one or both sides of the further hydrophobic polymer membrane layer.
41. The process of any of embodiments 21-40, further comprising attaching one or more of a collar, a hood, a zipper, a pocket, or findings.
42. A multi-layered fabric product containing a hydrophobic barrier seam, comprising:

an outer hydrophobic polymer membrane comprising two membrane panels joined at an outer seam, the outer seam comprising overlapping, adhesively joined edge portions of each of the two membrane panels;

an inner textile layer comprising two textile panels joined at an inner seam, the inner seam comprising overlapping, adhesively joined edge portions of each of the two textile panels;

wherein the outer hydrophobic polymer membrane and the inner textile layer are fused together over their surface areas to provide a laminated product, and the outer seam and the inner seam are in overlapping alignment to form the hydrophobic barrier seam.

43. The product of embodiment 42, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.
44. The product of any of embodiments 42-43, further comprising an adhesive layer between the outer hydrophobic polymer membrane and the inner textile layer.
45. The product of embodiment 44, wherein the adhesive layer is prepared from a powder adhesive, a web adhesive, a micro dot adhesive, or a nano dot adhesive.
46. The product of any of embodiments 42-45, wherein the outer hydrophobic polymer membrane is breathable or non-breathable.
47. The product of any of embodiments 42-46, further comprising a polymer layer coating disposed on an external surface of the hydrophobic polymer membrane.
48. The product of embodiment 47, wherein the polymer layer coating provides abrasion resistance.
49. The product of any of embodiments 42-48, further comprising a middle textile layer comprising two middle textile panels joined at a middle seam, the middle seam comprising overlapping, adhesively joined edge portions of each of the two middle textile panels, wherein the middle textile layer is disposed between the membrane and the inner textile layer and the middle seam is disposed between and aligned with the outer seam and the inner seam.
50. The product of embodiment 49, wherein the middle textile layer comprises one or more cut away regions through which the inner textile layer is visible through the outer polymer membrane.
51. The product of any of embodiments 49-50, wherein the middle textile layer comprises a garment shell fabric.
52. The product of any of embodiments 42-51, wherein the inner textile layer comprises a garment shell fabric or a garment lining fabric.
53. The product of any of embodiments 42-52, wherein the inner textile layer includes a pattern thereon, the pattern visible through at least a portion of the outer hydrophobic polymer membrane.
54. The product of any of embodiments 42-53, further comprising one or more additional hydrophobic polymer membranes with differing patterns or colors.
55. The product of any of embodiments 42-54, wherein the hydrophobic barrier seam includes no seam tape on an exterior surface of the hydrophobic barrier seam.
56. The product of any of embodiments 42-55, wherein the hydrophobic barrier seam includes no seam tape on an interior surface of the hydrophobic barrier seam.
57. The product of any of embodiments 42-56, wherein the hydrophobic barrier seam includes no seam tape on an exterior surface of the hydrophobic barrier seam or on an interior surface of the hydrophobic barrier seam.
58. The product of any of embodiments 42-57, further comprising a seam tape adhered between the inner seam and the outer seam within the hydrophobic barrier seam structure, the seam tape comprising a further hydrophobic polymer membrane layer and an adhesive layer on one or both sides of the further hydrophobic polymer membrane layer.
59. The product of any of embodiments 42-58, further including a sleeve seam of a garment, wherein the sleeve seam includes an ultrasonically welded seam or a sewn seam joining a sleeve to a garment body.
60. The product of any of embodiments 42-59, wherein the product comprises an article of clothing, a portion of an article of clothing, a jacket, a coat, a parka, a raincoat, a cloak, a poncho, a shirt, a blouse, pants, shoes, boots, a bootie liner, gloves, a hat, a hood, underwear, an undershirt, briefs, a bra, socks, a diaper, a protective suit for handling of hazardous materials, a protective suit for a firefighter, military personnel, or medical personnel, a blanket, a towel, a sheet, pet bedding, a tent, a sleeping bag, a tarp, a boat cover, carpeting, a rug, a mat, a window covering, or upholstery.
61. A process for fabricating a multi-layered fabric product containing a hydrophobic barrier seam, comprising:

(a) providing membrane panels of an outer hydrophobic polymer membrane and fabric panels of an inner textile layer;

(b) aligning each membrane panel to a corresponding one of the fabric panels to form a plurality of composite panels;

(c) fusing each of the composite panels together, with an area about a perimeter of each composite panel unfused;

(d) interleaving edge portions of the outer hydrophobic polymer membrane and the inner textile layer along the unfused perimeters of two adjacent composite panels; and

(e) fusing a plurality of the composite panels together to form the hydrophobic barrier seam along the interleaved edge portions and to form a continuous hydrophobic barrier across the adjacent composite panels extending over the hydrophobic barrier seam.

62. The process of embodiment 61, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.
63. The process of any of embodiments 61-62, further comprising providing an adhesive between the outer hydrophobic polymer membrane and the inner textile layer.
64. The process of embodiment 63, wherein the adhesive is prepared from a powder adhesive, a web adhesive, a micro dot adhesive, a nano dot adhesive.
65. The process of any of embodiments 61-64, further comprising providing a polymer layer coating disposed on an external surface of the outer hydrophilic polymer membrane.
66. The process of embodiment 65, wherein the polymer layer coating provides abrasion resistance.
67. The process of any of embodiments 61-66, wherein in step (c), the composite panels are fused together while laid flat.
68. The process of any of embodiments 61-67, further comprising providing a middle layer comprising two middle textile panels joined at a middle seam, the middle seam comprising overlapping, adhesively joined edge portions of each of the two middle textile panels, wherein the middle textile layer is disposed between the membrane and the inner textile layer and the middle seam is disposed between and aligned with the outer seam and the inner seam.
69. The process of embodiment 68, wherein the middle textile layer comprises one or more cut away regions through which the inner textile layer is visible through the outer polymer membrane.
70. The process of any of embodiments 68-69, wherein the middle textile layer comprises a garment shell fabric.
71. The process of any of embodiments 61-70, wherein the inner textile layer comprises a garment shell fabric or a garment lining fabric.
72. The process of any of embodiments 61-71, further comprising, prior to step (e), placing a seam tape between the inner seam and the outer seam within the hydrophobic barrier seam, the seam tape comprising a further hydrophobic polymer membrane layer and an adhesive layer on one or both sides of the further hydrophobic polymer membrane layer.
73. The process of any of embodiments 61-72, wherein the fabric product is a garment, and further including attaching a sleeve to body of the garment, wherein the sleeve seam includes an ultrasonically welded seam or a sewn seam joining a sleeve and to a garment body.
74. A process for fabricating a multi-layered fabric product comprising:

(a) providing fabric panels of a peelable laminate comprising at least two layers, including at least one fabric layer, a hydrophobic polymer membrane, and an adhesive between the fabric layer and hydrophobic polymer membrane;

(b) partially or fully peeling back at least one layer of the laminate;

(c) one or more of:
(i) inserting a component into the laminate where the at least one layer is peeled back;
(ii) removing one or the fabric layers from the laminate where the at least one layer is peeled back; and
(iii) forming at least one seam between adjacent fabric panels along adjacent peeled-back edges;

(d) folding the peeled-back layer back to reform the laminate; and

(e) fusing a plurality of the fabric panels together with a hard set to form a continuous hydrophobic barrier extending across the fabric panels.

75. A process for fabricating a multi-layered fabric product comprising:

(a) providing fabric panels of a peelable laminate comprising at least two layers, including at least one fabric layer, a hydrophobic polymer membrane, and an adhesive between the fabric layer and hydrophobic polymer membrane;

(b) peeling back one layer along at least a portion of a perimeter of adjacent fabric panels;

(c) forming at least one seam between adjacent fabric panels along adjacent peeled-back edges;

(d) folding the peeled-back edges back over the at least one seam; and

(e) fusing a plurality of the fabric panels together with a hard set to form a continuous hydrophobic barrier extending across the fabric panels and the at least one seam.

76. The process of embodiment 75, further comprising after step (c), inserting a component into the laminate where the at least one layer is peeled back.
77. The process of embodiment 76, wherein the component comprises one or more of electrical circuitry, an electrical component, an impact resistant component, and a medical component.

78. The process of any of embodiments 75-77, wherein the peelable laminate comprises at least three layers, including at least a second fabric layer, and further comprising after step (b), removing one of the fabric layers from the laminate.

79. The process of any of embodiments 75-78, further comprising in step (c), aligning the adjacent fabric panels with the hydrophobic polymer membrane on an outer surface of the fabric product.
80. The process of any of embodiments 75-79, further comprising in step (c) aligning the adjacent fabric pattern panels with the hydrophobic polymer membrane on an interior surface of the fabric product.
81. The process of any of embodiments 75-80, wherein in step (a), the fabric layer of the laminate is an outer shell fabric, and the laminate further includes an inner lining fabric, and the hydrophobic polymer membrane is disposed between the outer shell fabric and the inner lining fabric.
82. The process of embodiment 81, wherein the inner lining fabric comprises a knit fabric, a woven fabric, or a non-woven fabric.
83. The process of any of embodiments 75-82, wherein in step (a), the fabric layer of the laminate is an outer shell fabric, and the laminate further includes a tricot layer, and the hydrophobic polymer membrane is disposed between the outer shell fabric and the tricot layer.
84. The process of embodiment 83, wherein the tricot layer comprises a woven or non-woven fabric.
85. The process of any of embodiments 75-84, further comprising, prior to step (b), applying heat or steam to reactivate the adhesive to allow the hydrophobic polymer membrane or the at least one fabric layer to be peeled back.
86. The process of any of embodiments 75-85, wherein, in step (a), the laminate is formed with a soft set at a temperature and pressure that allows the at least one fabric layer or the hydrophobic polymer membrane to be peeled back.
87. The process of any of embodiments 75-86, wherein the hydrophobic polymer membrane comprises microporous or nanoporous polytetrafluoroethylene, expanded polytetrafluoroethylene, polyurethane, cross-linked polyurethane, polypropylene, polyester, or a waterproof non-breathable polymer film.
88. The process of any of embodiments 75-87, wherein the adhesive comprises microporous or nanoporous polyurethane, cross-linked polyurethane, polypropylene, or polyester.
89. The process of any of embodiments 75-88, wherein the adhesive is applied as a powder adhesive, a web adhesive, or a liquid adhesive in a micro dot or a nano dot pattern.
90. The process of any of embodiments 75-89, wherein the at least one fabric layer comprises a knit fabric, a woven fabric, or a non-woven fabric.
91. The process of any of embodiments 75-90, wherein in step (a), the peelable laminate is provided in a roll form.
92. A process for fabricating a multi-layered fabric product comprising:

(a) providing fabric panels of a peelable laminate comprising at least two layers, including at least one fabric layer, a hydrophobic polymer membrane, and an adhesive between the fabric layer and hydrophobic polymer membrane;

(b) peeling back one layer along at least a portion of a perimeter of adjacent fabric panels;

(c) inserting a component into the laminate where the at least one layer is peeled back;

(d) folding the peeled-back edges back to reform the laminate; and

(e) fusing a plurality of the fabric panels together with a hard set to form a continuous hydrophobic barrier extending across the fabric panels and the at least one component.

93. The process of embodiment 92, wherein the component comprises one or more of electrical circuitry, an electrical component, an impact resistant component, and a medical component.
94. The process of any of embodiments 92-93, wherein the component comprises a radio frequency identification component.
95. A process for fabricating a multi-layered fabric product comprising:

(a) providing fabric panels of a peelable laminate comprising at least three layers, including at least two fabric layers, a hydrophobic polymer membrane, and an adhesive between the fabric layer and hydrophobic polymer membrane;

(b) peeling back at least one layer;

(c) removing one of the fabric layers from the laminate where the at least one layer is peeled back;

(d) reforming the laminate; and

(e) fusing a plurality of the fabric panels together with a hard set to form a continuous hydrophobic barrier extending across the fabric panels.

### DESCRIPTION OF THE DRAWINGS

Reference is made to the following detailed description taken in conjunction with the accompanying drawings in which:

FIG. 1 is a schematic illustration of an embodiment of a hydrophobic barrier seam for a fabric product with an exterior hydrostatic barrier;

FIG. 2 is a schematic illustration of a further embodiment of a hydrophobic barrier seam;

FIG. 3 is a schematic illustration of a still further embodiment of a hydrophobic barrier seam;

FIG. 4 is a schematic illustration of a still further embodiment of a hydrophobic barrier seam;

FIG. 5 is a schematic illustration of a still further embodiment of a hydrophobic barrier seam;

FIG. 6 is a schematic illustration of a single body panel for a garment such as a jacket;

FIG. 7 is a schematic illustration of a single sleeve panel for a garment such as a jacket;

FIG. 8 is a schematic illustration of a sleeve formed from the single sleeve panel of FIG. 7;

FIG. 9 is a schematic partial cut away illustration of a jacket illustrating a shoulder seam and a sleeve seam;

FIG. 10 is a schematic illustration of a further embodiment of a hydrophobic barrier seam for a fabric product with an exterior hydrostatic barrier;

FIG. 11 is a schematic illustration of a still further embodiment of a hydrophobic barrier seam for a fabric product with an exterior hydrostatic barrier;

FIG. 12 is a schematic illustration of a still further embodiment of a hydrophobic barrier seam for a fabric product with an exterior hydrostatic barrier;

FIG. 13 is a schematic illustration of a still further embodiment of a hydrophobic barrier seam for a fabric product with an exterior hydrostatic barrier;

FIG. 14 is a schematic illustration of an embodiment of a peelable laminate;

FIG. 15 is a schematic illustration of a further embodiment of a peelable laminate;

FIG. 16 is a schematic illustration of a still further embodiment of a peelable laminate;

FIG. 17 is a schematic illustration of a still further embodiment of a peelable laminate;

FIG. 18A is a schematic illustration of a step in a process of fabricating a fabric product from a peelable laminate;

FIG. 18B is a schematic illustration of a further step in the process of fabricating a fabric product from a peelable laminate;

FIG. 18C is a schematic illustration of a further step in the process of fabricating a fabric product from a peelable laminate;

FIG. 19 is a schematic illustration of an embodiment of a product formed from a peelable laminate;

FIG. 20A is a schematic illustration of a step in a process of fabricating a product from a peelable laminate with an added component;

FIG. 20B is a schematic illustration of a further step in the process of fabricating a product from a peelable laminate with an added component; and

FIG. 20C is a schematic illustration of a further step in the process of fabricating a product from a peelable laminate with an added component.

### DETAILED DESCRIPTION

In one aspect, a fabric product is provided with an outer or exterior hydrostatic barrier and a hydrostatic barrier seam. The hydrostatic barrier prevents or minimizes the infiltration of moisture. In many cases, a hydrostatic barrier seam tape along the seams is not required to maintain the continuous hydrostatic barrier. The barrier seam can provide the same level of moisture barrier as a hydrophobic polymer membrane used in the outer hydrostatic barrier. In some cases, a seam tape can be included between a hydrostatic barrier and an inner fabric, for example, to provide additional structural reinforcement or strengthening of the seam.

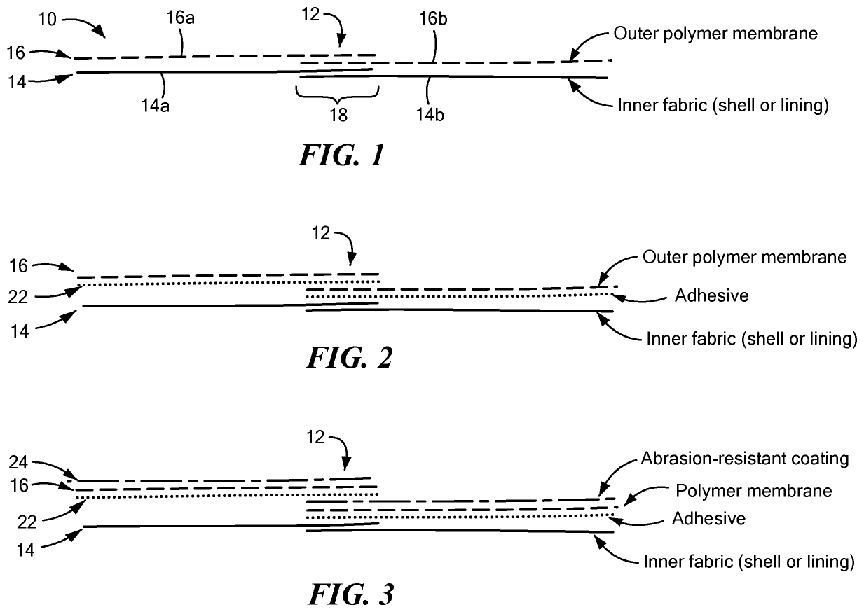

Referring to FIG. 1, a fabric product 10 with a hydrostatic barrier seam 12 includes an inner fabric or textile layer 14 and an outer hydrophobic polymer membrane 16. The inner fabric can be a garment shell fabric or a garment lining fabric. Each of the inner fabric and the outer membrane can be provided as panels 14a, 14b, 16a, 16b, cut to an appropriate pattern, such as a component of a garment, for example, a body panel, a sleeve, a collar, a hood, or another component. The pattern panels can be fused together with an area around the perimeter left unfused or with a soft set that allows the edge portions 18 around the perimeter to be peeled back. The unfused or folded back perimeter allows the edges of the layers to be interleaved or overlapped to form a hydrophobic barrier seam 12, as shown in FIG. 1. The barrier seam can be subsequently set with a hard fuse, for example, during the fusing of all of the layers of the fabric product to complete the lamination process and form the complete fabric product. In this manner, the barrier layer is not compromised during the fabrication of the product.

In some embodiments, the outer hydrophobic polymer membrane can be microporous or nanoporous polytetrafluoroethylene, expanded polytetrafluoroethylene, polyurethane, cross-linked polyurethane, polypropylene, polyester, or a waterproof nonporous polymer film. The hydrophobic polymer membrane can be a layer or film of synthetic or natural polymers that resists the passage of liquid water, in the form of droplets or microdroplets, across the membrane. In some embodiments, the hydrophobic polymer membrane allows the passage of water vapor, in the form of individual water molecules, so as to promote breathability of the laminated fabric. A hydrophobic polymer membrane can comprise or be prepared from a material such as microporous or nanoporous polytetrafluoroethylene (PTFE), expanded PTFE (ePTFE), polyurethane, cross-linked polyurethane, polypropylene, or polyester. In some embodiments, a membrane can comprise or be prepared from graphene or a graphene-based material. In some embodiments, a filler material or coating can be used to provide surface roughness and/or insulation. One example of a waterproof laminated fabric is Gore-Tex® fabric (see, e.g., U.S. Pat. No. 3,953,566), which utilizes a porous PTFE membrane as the hydrophobic polymer membrane. The PTFE membrane of a GoreTex® fabric has a microstructure characterized by nodes interconnected by fibrils. The microporous or nanoporous nature of the PTFE membrane is such that water droplets are excluded from the pores, whereas water molecules can pass through the pores. A further example of a laminate with a durable outer film surface is disclosed in U.S. Pat. No. 9,006,117.

In some embodiments, the hydrophobic polymer membrane can be breathable to allow transmission of water vapor therethrough. In some embodiments, the hydrophobic polymer membrane can be non-breathable. In some embodiments, the hydrophobic polymer membrane can be resistant to at least one of pathogenic microorganisms, blood borne pathogens, viruses, bacteria, liquid chemical agents, and gaseous chemical agents. In some embodiments, membranes and fabrics can be certified to meet standards for chemical and biological resistance, such as those of the National Fire Protection Association.

In some embodiments, the product can include a middle textile layer comprising two middle textile panels joined at a middle seam. The middle seam can comprise overlapping, adhesively joined edge portions of each of the two middle textile panels. The middle textile layer is disposed between the membrane and the inner textile layer, and the middle seam is disposed between and aligned with the outer seam and the inner seam. In some embodiments, the middle textile layer can be a garment shell fabric and the inner fabric layer can be an inner lining.

In some embodiments, the inner fabric or textile layer can include a pattern thereon that can be visible through at least a portion of the outer hydrophobic polymer membrane. In some embodiments, the middle textile layer if present can include one or more cut away regions through which the inner textile layer is visible through the outer polymer membrane. In some embodiments, the product can include one or more additional hydrophobic polymer membranes with differing patterns or colors. In some embodiments, a hydrophobic polymer membrane can include a pattern printed on one side, for example, by a transfer printing process. In some embodiments, the hydrophobic polymer membrane can be a single or uniform pattern piece or can be multiple pieces of different types of membrane films, coatings and/or inserted panels to create a two-dimensional or three-dimensional see-through outline of a fabric design, color, logo, or other artwork.

In some embodiments, the inner lining fabric can have a fabric design, color, logo, or artwork. An outer surface of the inner lining fabric can face towards the outside of the garment. This can allow the fabric pattern of the inner lining fabric to show through the membrane pattern panel. In some embodiments, an inner surface of the inner lining fabric could face towards the inside of the garment. This can allow the fabric pattern of the inner lining fabric to show on the inside of the garment.

In some embodiments, the inner fabric 14 and any additional fabric layer or layers, such as a middle textile layer, can be any fabric, such as a knit, woven, or non-woven or fleece fabric from one or more yarns of a synthetic, semi-synthetic, or natural material. The inner fabric and/or an additional layer or layers can be an insulation layer or an insulating fabric. Materials for the inner fabric and any additional layer or layers can include, for example, a polyester, a polyamide, a polyvinylchloride, a polyketone, a polysulfone, a polycarbonate, a fluoropolymer, a polyacrylate, a polyurethane, a co-polyetherester, a polypropylene, a co-polyetheramide, and a polyethylene terephthalate. Materials for the inner fabric and/or any additional layer or layers can also include cotton, wool, silk, or rayon. The inner fabric and/or any additional layer or layers can have any desired color, texture, or pattern, and can be dyed or impregnated as needed to achieve a desired appearance or functionality. The inner fabric and/or any additional layer or layers can contain elastic fibers, such as spandex or elastane, to create stretch characteristics. Lycra® fibers, a type of spandex, are a polyurethane polyurea copolymer that can be woven into a fabric to provide elasticity. Alternatively or additionally, elasticity or stretch can be provided by using a woven or non-woven fabric having stretch in at least one direction. In some embodiments, all layers in a multi-layered fabric product provide a similar or essentially identical degree of stretch for optimum comfort and non-restrictive feel of the garment. A fleece fabric can be any fleece, such as a fleece made of polyethylene terephthalate (PET), and can have any texture, color, or thickness as desired or as appropriate for a particular garment. The fleece is preferably insulating, breathable, and soft to the touch. Chemical substances such as flammability retarding agents can be also added to an inner fabric and/or to any additional layer or layers.

As used herein, a “soft set” fuse is a lamination process that allows the layers to be peeled back without damaging the surface structures. A soft set fuse also allows an operator to re-heat the adhesive and realign or stretch out the hydrophobic polymer membrane or fabric, for example, to repair any pressing errors. A “hard set” fuse is a lamination process that permanently sets the layers in place. In some embodiments, when fusing fabric layers with a soft set fuse, the press is set to a temperature of approximately 225° F. at zero pressure to allow the adhesive to flow to create an initial bond between the surfaces. This initial bond allows the individual layers to be pulled away from the other layers. In some embodiments, the adhesive can be reactivated to reform a bond between the surfaces. In some embodiments, when fusing fabric layers with a hard set fuse, the press is set to a temperature between 235° F. to 275° F. at 40 psi to 50 psi for 20 to 40 seconds. After pressing, the composite fabric is cooled under vacuum to set the adhesives into place and permanently laminate the fabric panels together.

As indicated in FIG. 2, an adhesive 22 can be located between the outer hydrophobic polymer membrane 16 and the inner fabric 14. In the embodiment shown, the adhesive is provided on an inwardly-facing surface of the outer hydrophobic polymer membrane. The adhesive can be prepared from a powder adhesive, a web adhesive, a micro dot adhesive, or a nano dot adhesive. The specific type and weight of the adhesive composite is selected for the type of fabric product being produced. The adhesive can be selected to withstand any laundering processes that the fabric product may undergo, such as washing, drying, dry cleaning, and ironing. The amount of adhesive can be increased or decreased as required by the type of inner fabric and hydrophobic polymer membrane combination or other combination of fabric and membrane layers. Suitable adhesives can include, but are not limited to, polyurethane, polypropylene, polyamide, polyester, and polyolefin adhesives. An adhesive polymer can be cross-linked or non-cross-linked. Adhesives are typically measured in grams per square yard. The process can reduce a negative impact on the moisture vapor transmission rate (MVTR) over the hydrophobic polymer membrane surface, by reducing the use of adhesives over the area of the hydrophobic polymer membrane surface. The adhesives can be applied in a discontinuous pattern, such as in a dot, line, or grid pattern, or in no regular pattern, to minimize the amount of adhesive. Suitable adhesives are commercially available from various suppliers such as Bostik SA or 3M Company.

In some embodiments, the hydrophobic polymer membrane can be a multi-layer thermoplastic composite, thereby eliminating the need for additional adhesives or decreasing the amount of adhesives that are required. (See, for example, FIG. 1.) For example, in some embodiments, a low melt membrane film can be provided on one or both sides of a high melt membrane film, to enhance the subsequent adhesion to another layer by a chemical and thermal mechanical bond. The low melt film melts at a lower temperature than the high melt film, providing adhesion at a reduced temperature, for example, to provide temporary adhesion during a garment fabrication process. In some embodiments, the presence of a low melt membrane film can allow for a reduction in the amount of additional adhesives, such as micro-dot, nano-dot, powdered, or web adhesives, that would otherwise be needed. In some embodiments, the melting temperature of the high melt membrane film can be, for example, 5, 10, 15, 20, 30, 40, or 50° C. or more higher than the melting temperature of the low melt membrane film.

In some embodiments, the high melt membrane film can be formed from a variety of suitable materials, such as a polyester, polyether, polypropylene, polyurethane, expanded polytetrafluoroethylene (ePTFE) or polytetrafluoroethylene material. The high melt film can be breathable or non-breathable. In some embodiments, the low melt membrane film can be formed from a variety of suitable materials, such as a polyester, polyether, polypropylene or polyurethane material. The low melt film can be breathable or non-breathable.

In some embodiments, a hydrophobic polymer membrane can include a high melt thermoplastic polyurethane (TPU) membrane film, and a low melt TPU membrane film can be provided on one or both sides of the high melt TPU membrane film. In some embodiments, the hydrophobic polymer membrane can include a high melt ePTFE membrane film, and a low melt TPU membrane film can be provided on one or both surfaces of the high melt ePTFE membrane film. In some embodiments in which low melt membrane films are provided on both surfaces of a high melt membrane film, the low melt membrane films can have different melt temperatures or different degrees of cross-linking from each other.

FIG. 3 illustrates an embodiment in which an abrasion-resistant coating 24 is disposed on an outwardly-facing surface of the outer hydrophobic polymer membrane 16. In some embodiments, an abrasion resistant coating 24 can be provided as an additional layer. The coating or layer can have one or more of a thickness, density, pore size, molecular weight, or other property selected to impart abrasion resistance. The abrasion resistant coating or layer can be microporous or nanoporous polytetrafluoroethylene, expanded polytetrafluoroethylene, polyurethane, cross-linked polyurethane, polypropylene, polyester, polystyrene, polyvinyl chloride, polyethylene, fluoropolymer, or a waterproof nonporous polymer film. In some embodiments, a ceramic coating can be used, such as a ceramic coating commercially available from Schoeller Textil AG of Switzerland. In some embodiments, a filler material, such as Expancel thermoplastic microspheres commercially available from AkzoNobel Chemical Products, can be used to provide surface roughness and/or insulation. In some embodiments, an abrasion resistant or protective coating or film commercially available as NORFILM™ from Saint-Gobain Performance Plastics Corporation can be used. The hydrophobic polymer membrane and the abrasion resistant coating can be provided as a laminate, as shown in FIG. 3, in which edge portions are interleaved or overlapped as described above to create an outer seam of the hydrophobic barrier seam.

An inner coating can be provided on the hydrophobic polymer membrane. In some embodiments, the inner coating can be microporous or nanoporous polytetrafluoroethylene, expanded polytetrafluoroethylene, polyurethane, cross-linked polyurethane, polypropylene, polyester, or a waterproof nonporous polymer film. The inner coating can be a woven or non-woven fabric or tricot or other lightweight fabric.

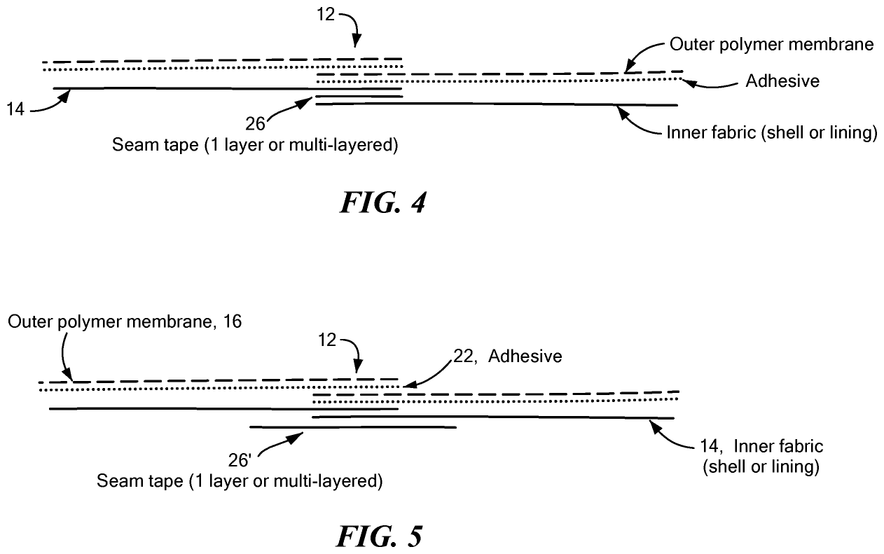

FIG. 4 illustrates an embodiment in which a seam tape 26 is also employed along the hydrophobic seam, which can be useful, for example, for structurally reinforcing or strengthening the seam. The seam tape can be interleaved within the seam, for example, between edges of the inner fabric 14, as shown in FIG. 4. FIG. 5 illustrates a further embodiment in which seam tape 26′ is applied along the seam on the interior of the product. The seam tape can be a single layer ply of an adhesive material, or it can be multi-layered or multi-plied. For example, a single layer can be an adhesive polymer layer. In some embodiments, a single layer adhesive can be a layer of a low melt adhesive that can be used to bond fabric to fabric surfaces or to bond hems. A multi-layered seam tape can include a hydrophobic polymer membrane layer with an adhesive layer on each surface. In some embodiments, the seam tape can include a high melt hydrophobic polymer membrane with low melt adhesive layers on each surface to create a hydrostatic barrier.

In some embodiments, an ultrasonic seam tape can be used. An ultrasonic seam tape can be a multi-ply seam tape composite comprising a low melt adhesive, a restrictive/non-stretch tricot fabric, and a low melt adhesive. Such a multi-ply seam tape can be used, for example, to create additional seam strength in an ultrasonic seam. In some embodiments, an ultrasonic-hydrostatic seam tape can be used. An ultrasonic-hydrostatic seam tape can be a multi-ply seam tape composite comprising a low melt adhesive, a high melt membrane barrier film, a restrictive/non-stretch tricot fabric, and a low melt adhesive, for example, to create addition seam strength in an ultrasonic-hydrostatic seam.

In some embodiments, a multi-layered fabric product containing a hydrophobic barrier seam includes an outer hydrophobic polymer membrane comprising two membrane panels joined at an outer seam. The outer seam comprises overlapping, adhesively joined edge portions of each of the two membrane panels. The product also includes an inner textile layer comprising two textile panels joined at an inner seam. The inner seam comprises overlapping, adhesively joined edge portions of each of the two textile panels. The outer hydrophobic polymer membrane and the inner textile layer are fused together over their surface areas to provide a laminated product, and the outer seam and the inner seam are in overlapping alignment to form the hydrophobic barrier seam.

In some embodiments, the hydrophobic barrier seam can include no seam tape on an exterior surface of the hydrophobic barrier seam.

In some embodiments, the product can include a sleeve seam of a garment. The sleeve seam can be an ultrasonically welded seam or a sewn seam joining a sleeve to a garment body.

In some embodiments, a process for fabricating a garment or other fabric product having waterproof exterior hydrostatic barrier is provided.

In some embodiments, a process for fabricating a multi-layered fabric product containing a hydrophobic barrier seam comprises:

(a) providing membrane pattern panels of an outer hydrophobic polymer membrane and fabric pattern panels of an inner textile layer;

(b) aligning each membrane pattern panel to a corresponding one of the fabric pattern panels to form a plurality of composite pattern panels;

(c) fusing each of the composite pattern panels together, leaving an area about a perimeter of each composite pattern panel unfused;

(d) interleaving edge portions of the outer hydrophobic polymer membrane and the inner textile layer along the unfused perimeters of two adjacent composite pattern panels; and

(e) fusing a plurality of the composite pattern panels together to form the hydrophobic barrier seam along the interleaved edge portions and to form a continuous hydrophobic barrier across the adjacent composite pattern panels extending over the hydrophobic barrier seam.

In some embodiments, in step (c), the composite pattern panels can be fused together while laid flat.

In some embodiments, the process can further include, prior to step (e), placing a seam tape between the inner seam and the outer seam within the hydrophobic barrier seam. The seam tape can comprise a further hydrophobic polymer membrane layer and an adhesive layer on one or both sides of the further hydrophobic polymer membrane layer.

In some embodiments, the fabric product can be a garment, and the process can further include attaching a sleeve to a body of the garment. The sleeve seam can be an ultrasonically welded seam or a sewn seam joining the sleeve and to a garment body.

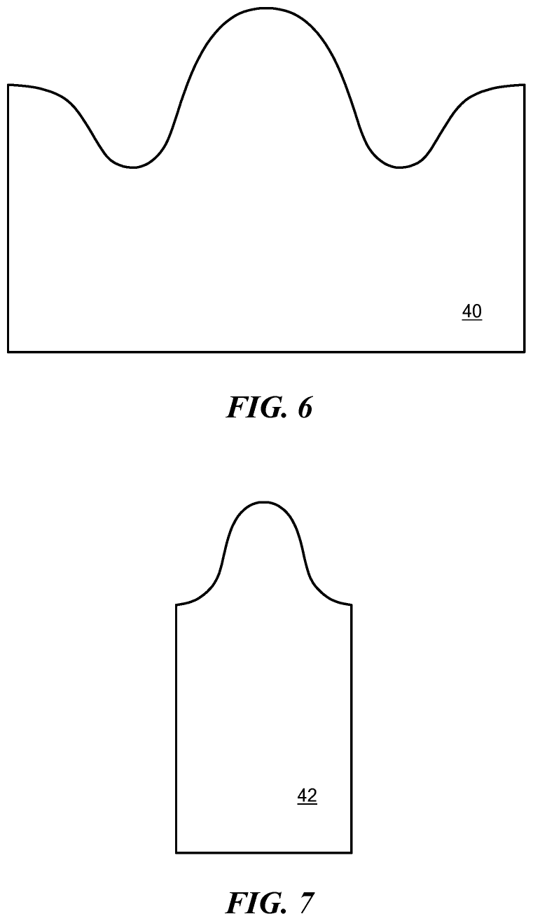

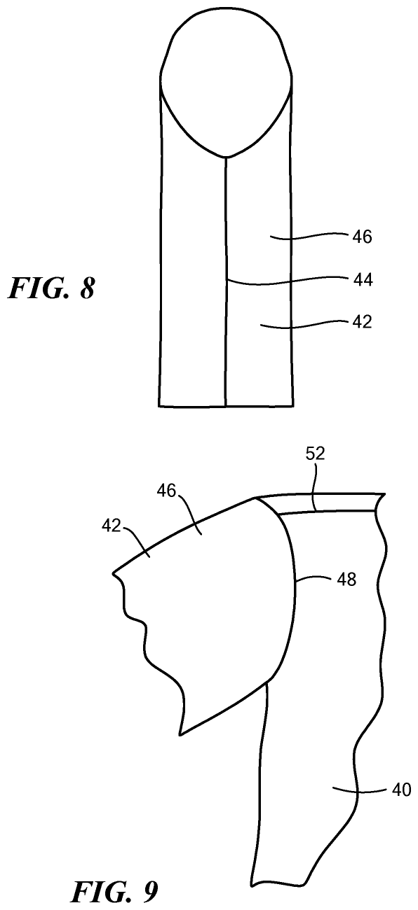

In another aspect, a fabric garment having an exterior hydrostatic barrier, such as a jacket, can be provided with a continuous body panel constructed to minimize the number of seams. As an example, a jacket can include a single body panel 40 having no side seams and two sleeve panels 42, each joined along seams 44 to form a sleeve 46. The sleeves are joined to the single body panel along sleeve seams 48. See FIGS. 6-9. Shoulder seams 52 can be provided in the body panel 40 at each sleeve. Each of the sleeve and shoulder seams can be constructed to form a hydrophobic barrier seam. In the finished garment, no side seams are visible on the interior or exterior of the garment body, while shoulder and sleeve seams are visible on both the interior and exterior.

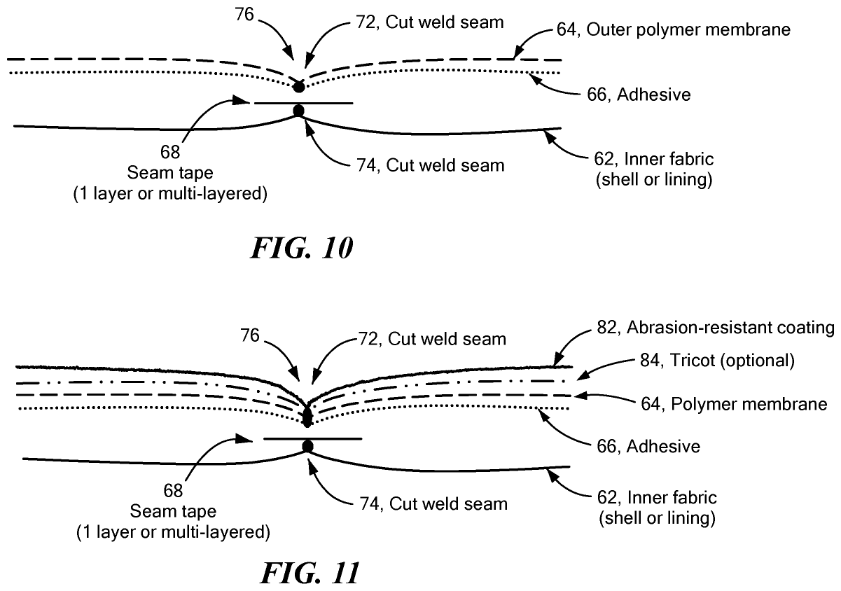

Referring to FIGS. 10-13, in some embodiments, each panel can include at least an inner fabric or textile layer 62 and an outer hydrophobic polymer membrane 64 fused together over their surfaces while the panels are laid out flat. An adhesive 66 can be provided on the interior surface of the outer hydrophobic polymer membrane, as described above. Appropriate edge portions are left unfused or, if fused with a soft set, peeled back to allow construction of the seams or incorporation of a zipper, collar, hood, or other findings. Sleeve and shoulder seams can be formed with an outer seam 72 having joined edge portions of adjacent panels of the hydrophobic polymer membrane 64 and with an inner seam 74 having joined edge portions of adjacent panels of the inner textile layer 62. The outer seam 72 and the inner seam 74 are then adhesively sealed in alignment to form a hydrophobic barrier seam 76. In some embodiments, each outer seam 72 and inner seam 74 is separately formed as a cut weld seam. Seam tape 68 can be used to structurally reinforce the hydrophobic barrier seam and enhance the hydrostatic property. After one of the inner and outer seams is formed, a seam tape (which can be single or multi-layered) can be placed over the formed inner or outer seam to lie between the hydrophobic polymer membrane and the inner textile layer. In some embodiments, shown in FIG. 11, an abrasion resistant coating 82 and a tricot layer 84 can be applied on an exterior surface of the hydrophobic polymer membrane. It will be appreciated that, although FIG. 11 illustrates both an abrasion resistant coating and a tricot layer, in some embodiments, one or the other of an abrasion resistant coating and a tricot layer can be used.

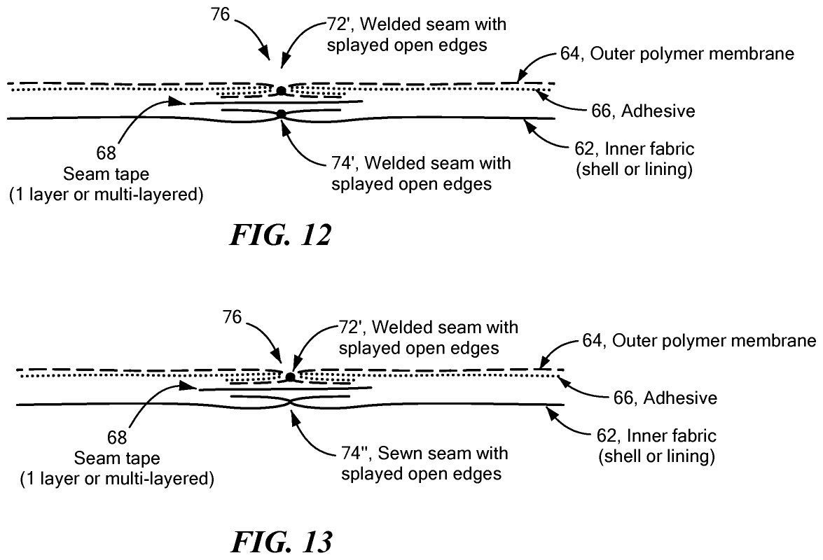

Referring to FIG. 12, in some embodiments, the outer seam 72′ can include a welded seam with splayed open edges. Similarly, the inner seam 74′ can include a welded seam with splayed open edges. Referring to FIG. 13, the inner seam 74″ can include a sewn seam with splayed open edges. The outer seam is preferably not sewn to avoid any punctures through the hydrophobic polymer membrane. In some embodiments, the inner and outer seams can be formed with overlapping or interleaved edges as described above in conjunction with FIGS. 1-5.

Once the inner and outer seams are formed, other components, such as a collar, hood, zipper, and other findings can be attached. The entire garment can be fused, for example, with a three-dimensional pressing machine, to hard set the adhesives and form the continuous hydrostatic barrier.

In some embodiments, a fabric garment includes a single body panel and two sleeve panels. Each of the single body panels and the two sleeve panels comprises an outer hydrophobic polymer membrane and an inner textile layer fused together over their surfaces. The single body panel is a continuous panel, and the two sleeve panels are joined to the single body panel along sleeve seams. The single body panel includes a shoulder seam at each sleeve seam. Each of the sleeve seams and the shoulder seams can include an outer seam comprising joined edge portions of adjacent panels of the hydrophobic polymer membrane and an inner seam comprising joined edge portions of adjacent panels of the inner textile layer. The outer seam and the inner seam can be adhesively sealed in alignment to form a hydrophobic barrier seam.

In some embodiments, the body panel can extend continuously from one side of a front opening to another side of a front opening. In some embodiments, the body panel has no side seams.

In some embodiments, the outer seam is joined by ultrasonic welding. In some embodiments, the edge portions of the outer seam can be overlapping. In some embodiments, the hydrophobic polymer membrane is not punctured or sewn along the outer seam.

In some embodiments, the inner seam can be joined by ultrasonic welding or sewing. In some embodiments, the edge portions of the inner seam are overlapping.

In some embodiments, the product can include a seam tape adhered between the inner seam and the outer seam within the hydrophobic barrier seam structure. The seam tape can comprise a further hydrophobic polymer membrane layer and an adhesive layer on one or both sides of the further hydrophobic polymer membrane layer. The seam tape can be single-ply or multi-ply, as described above.

In some embodiments, the fabric garment can include one or more of a collar, a hood, a zipper, a pocket, or findings.

In some embodiments, a process for fabricating a garment can comprise:

(a) providing fabric pattern panels of at least an inner textile layer comprising a single body panel and two sleeve panels;

(b) providing membrane pattern panels of at least a hydrophobic polymer membrane corresponding to the single body panel and the two sleeve panels;

(c) aligning each membrane pattern panel to a corresponding fabric pattern panel with the hydrophobic polymer membrane on an exterior surface of the inner textile layer, each membrane pattern panel and each corresponding fabric pattern panel laid out flat to form a plurality of composite fabric pattern panels;

(d) fusing each of the composite pattern panels together, leaving an area about a perimeter of each composite fabric pattern panel unfused;

(e) joining the composite pattern panels together at sleeve seams and shoulder seams, each sleeve seam and shoulder seam comprising an outer seam comprising joined edge portions of adjacent panels of the hydrophobic polymer membrane and an inner seam comprising joined edge portions of adjacent panels of the inner textile layer, the outer seam and the inner seam adhesively sealed in alignment to form a hydrophobic barrier seam.

In some embodiments, in step (e), the outer seam can be joined by ultrasonic welding. In some embodiments, in step (e), the edge portions of the outer seam can be overlapping.

In some embodiments, in step (e), the hydrophobic polymer membrane is not punctured along the outer seam.

In some embodiments, in step (e), the inner seam can be joined by ultrasonic welding or sewing. In some embodiments, in step (e), the edge portions of the inner seam can be overlapping.

In some embodiments, the membrane pattern panel can further include a polymer layer coating disposed on an external surface of the hydrophobic polymer membrane. The polymer coating provides abrasion resistance. In some embodiments, the membrane pattern panel can further include a tricot layer disposed between the hydrophobic polymer membrane and the polymer layer coating.

In some embodiments, the process can include in step (e), inserting a seam tape between the inner seam and the outer seam within the hydrophobic barrier seam structure. The seam tape can comprise a further hydrophobic polymer membrane layer and an adhesive layer on one or both sides of the further hydrophobic polymer membrane layer.

In some embodiments, the process can include attaching one or more of a collar, a hood, a zipper, a pocket, or findings.

One exemplary process to fabricate a garment with an outer hydrophobic polymer membrane and an inner lining fabric, such as a jacket, is described as follows:

1) To form the body of the garment, the inner lining fabric pattern panels are ultrasonically cut and welded or cut and sewn to the desired garment pattern. The garment body pattern can be laid out flat. Any zippers, pockets or other findings that are required on the inside of the garment can be welded or sewn on the inside of the garment.

2) Sleeves of the garment can be cut out of the inner lining fabric pattern panels to the desired sleeve pattern. The garment sleeves can be laid out flat. Any desired findings can be welded to sewn to the sleeves.

3) A collar and/or hood of the garment can be cut out of the inner lining fabric pattern panels to the desired collar and/or hood pattern. Depending on the pattern, the garment collar and/or hood can be laid out flat or in a later step, can be vacuum form laminated in a three-dimensional pattern. Any desired findings can be welded or sewn to the collar and/or hood.

4) The membrane pattern panels are cut and fused using a soft set to the outer surface of the garment body (from step 1), for example, through a vacuum formed lamination using a vacuum tray with a variable heat platen or heat/steam iron, if not already laminated to the inner lining fabric.

A perimeter, for example, approximately ½ inch, of the inner lining fabric and the membrane can be left unfused to allow the two pieces to be peeled back and ultrasonically cut and welded or sewn together in a subsequent step.

A perimeter, for example, approximately ½ inch, around a pocket zipper or findings, if present, can be left unfused or unpressed.

As noted above, the hydrophobic polymer membrane in the body can be a single or uniform pattern piece or can be multiple pieces of different types of membrane films, coatings and/or inserted panels to create a two-dimensional or three-dimensional see-through outline of a fabric design, color, logo, or other artwork.

5) Any sleeves of the garment can be cut out of membrane film to form the membrane pattern panels in the desired sleeve pattern. The sleeves from step 2 are fused to the membrane pattern panels using a soft set to hold the hydrophobic polymer membrane to the outer surface of the inner fabric lining. The vacuum formed lamination process is created by using a vacuum tray with a variable heated platen and a cooling cycle or by a heat/steam iron. A perimeter, for example, approximately ½ inch, of the sleeve inner lining fabric and membrane film is left unpressed to allow separation of the two pieces to be peeled back and ultrasonically cut and welded or sewn in a separate step. The membrane film in the sleeve can be a single or uniform pattern piece or multiple pieces of different types of membrane films, coatings and/or inserted panels to create a two-dimensional or three-dimensional see-through outline of a logo or other artwork.

6) Any collar and/or hood can be cut out of the membrane film to form the membrane pattern panels in the desired collar and/or hood pattern. The collar and/or hood from step 3 can be fused to the membrane pattern panels using a soft set to hold the hydrophobic polymer membrane film to the outer surface of the inner fabric lining. The lamination can be created using a three-dimensional vacuum formed mold with variable heat platen and a cooling cycle or by heat/steam iron. A perimeter, for example, approximately ½ inch, of the inner lining fabric and membrane film is left unpressed to allow that the two pieces to be peeled back and ultrasonically cut and welded or sewn in a separate step. The membrane film in the collar and/or hood can be a single or uniform pattern piece or multiple pieces of different types of membrane films, coatings and/or inserted panels to create a two-dimensional or three-dimensional see-through outline of a logo or other artwork.

7) The membrane film of the sleeves and the garment body is peeled back, and the sleeve and shoulder seams are ultrasonically welded and cut to connect the membrane film of the sleeves to the membrane film of the shoulder to create the outer sleeve and shoulder welded membrane film seam structures.

8) The inner lining fabric of the sleeves and body are peeled backs and the sleeve and shoulder seams are ultrasonically cut and welded or sewn to connect the inner lining fabric of the sleeves to the inner lining fabric of the shoulder to create the inner sleeve/shoulder fabric seam structures.

9) The membrane film of the collar and/or hood and of the body are peeled back and the seams are ultrasonically cut and welded to connect the membrane film of the collar and/or hood to the membrane film of the body collar to create the collar/hood/body welded seam membrane film structure.

10) The inner lining fabric of the collar and/or hood and of the body are peeled back and the seams are ultrasonically cut and welded or sewn to connect the inner lining fabrics of the garment body to the collar and/or hood to create the inner collar/hood seam structure.

11) If the adhesive qualities of the ultrasonic welded membrane film seam and the inner sleeve/body fabric seam are not acceptable, a seam tape can be used. The seam tape can be positioned, either manually or by using a seam tape machine, around the perimeter of the outer sleeve/body welded membrane film seam structures or the sewn sleeve/body fabric seam structures. The seam set can be fused using a soft set.

12) Ultrasonically weld or sew a garment hem of the garment body into place.

13) Fuse the unpressed membrane film around the zippers, pocket zippers or required findings and press into position using a soft set.

14) Fuse all the unpressed membrane film sleeve seams and inner lining fabric sleeve seams to create the three-dimensional garment assembly using a soft set.

15) Inspect the three-dimensional garment assembly to ensure that the inner lining fabric and the membrane film are properly aligned and correct any pressing errors. Hard set the garment assembly. The hard set also creates a hydrostatic seal of the seam tape if applied in step 11.

In a further aspect, a process for fabricating a multi-layered fabric product can incorporate a peelable laminate that allows one or more of the layers to be peeled back to construct a seam or to remove and replace a layer with another fabric or membrane without losing the adhesive qualities of the laminate. In some embodiments, one or more layers can be peeled back to enable insertion of one or more additional components. For example, an additional component can be a component that requires protection from the environment. In some embodiments, an additional component can be electrical circuitry or an electrical component, such as radio frequency identification (RFID) circuitry or components. In some embodiments, an additional component can be an impact resistant component or product or a medical component or product. The ability to peel back one or more layers of a laminate allows access to manipulate each individual layer.

In some embodiments, the laminate can be formed in a large quantity as a single sheet in a first location and rolled up for transportation to a second location for subsequent fabrication into a fabric product. During the fabrication process, each layer of the laminate can be made accessible to form the seams by peeling back the appropriate layer or layers. Seam tape is not required along the seams, although seam tape could be used for structural reinforcement or for additional protection for an exterior interleaved seam.

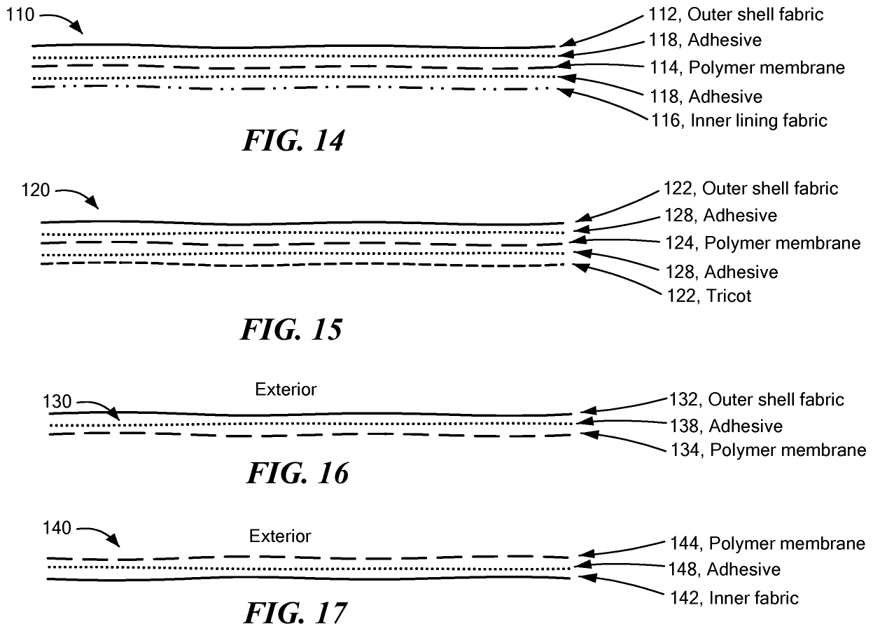

A peelable laminate can be formed with a variety of layers. For example, in some embodiments, a laminate 110 can include an outer shell fabric 112, a hydrophobic polymer membrane 114, and an inner lining fabric 116. See FIG. 14. Adhesives 118 are provided between each layer. In some embodiments, a laminate 120 can include an outer shell fabric 122, a hydrophobic polymer membrane 124, a tricot layer 126, and adhesives 128. See FIG. 15. In some embodiments, a laminate 130 can include an outer shell fabric 132, a hydrophobic polymer membrane 134, and adhesives 138 (FIG. 16). In some embodiments, a laminate 140 can include an outer hydrophobic polymer membrane 144, an inner fabric 142, and adhesives 148 (FIG. 17).

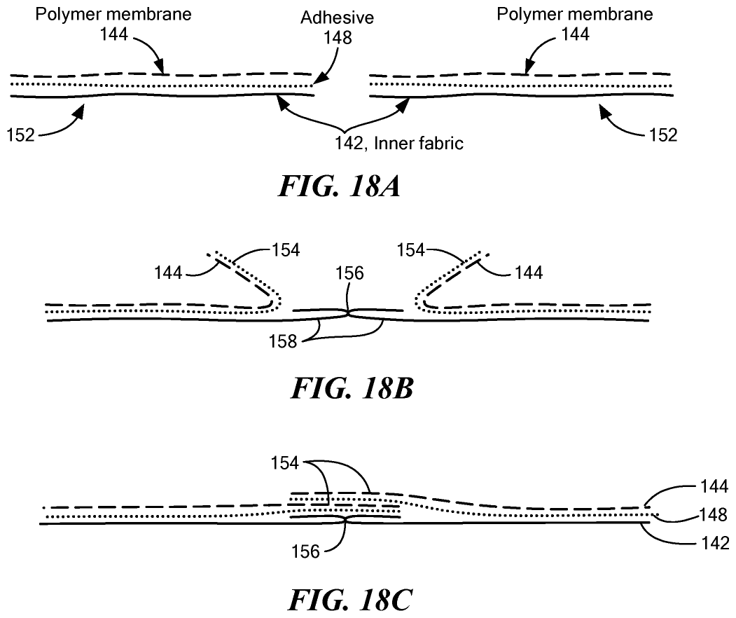

The laminate is formed with a soft set, as described above, to allow each layer to be peeled back as needed to construct the seams, while leaving the adhesive in place. For example, referring to FIGS. 18A-C, a laminate can be cut into desired fabric pattern panels 152. In the embodiment illustrated, the laminate is an outer hydrophobic polymer membrane 144 and an inner fabric 142 with an adhesive 148 between, as shown in FIG. 17. Edge portions 154 of the hydrophobic polymer membrane 144 of adjacent panels 152 can be peeled back, as shown in FIG. 18B. In some embodiments, heat or steam can be applied to soften the adhesive to allow the laminate to be peeled back. A seam 156, illustrated as a welded or sewn seam with splayed open edges, is formed along the now-accessible edge portions 158 of the inner fabric. The edge portions 154 of the hydrophobic polymer membrane 144 are then folded back over the seam 156. The adhesive 148 can be reactivatable to adhere to the fabric layers once the layers are folded back. A hard set fuse, as described above, can be applied to the final product to set the adhesives. In some embodiments, using a peelable laminate as described herein, an entire layer can be removed and replaced with a different layer.

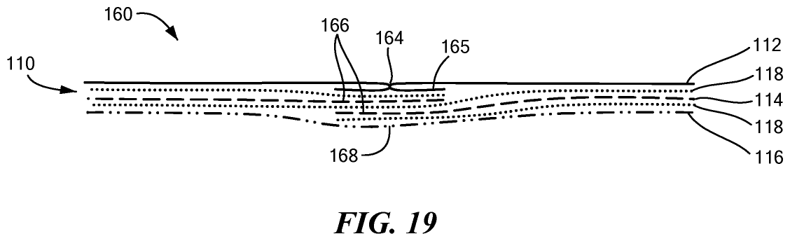

FIG. 19 illustrates another example of a fabric product 160 with a finished seam 162, using a peelable laminate 110 as shown in FIG. 14, having an outer shell fabric 112, an inner lining fabric 116, and a hydrophobic polymer membrane 114 in between, with adhesive 118 on both side of the hydrophobic polymer membrane. The layers are peeled back, with adhesive retained both sides of the hydrophobic polymer membrane. An outer seam 164, with folded-back edges 165, is formed between adjacent panels of the outer shell fabric 112. The seam can be formed by welding or sewing. The hydrophobic polymer membrane, with adhesive on both sides, is folded back over the outer seam with edges 166 interleaved or overlapping. A cut weld seam 168 is formed along the inner lining fabric 116. The adhesive 118 can be reactivatable to adhere to the fabric layers once the layers are folded back. A hard set fuse, as described above, can be applied to the final product to set the adhesives. Seam tape is not required in this construction to maintain a continuous hydrophobic barrier across the seam.

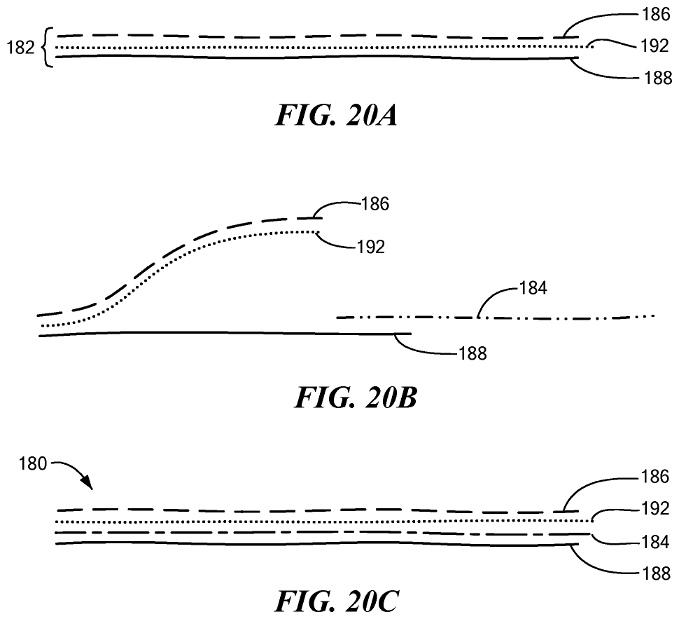

FIGS. 20A-C illustrate another example of a fabric product 180 using a peelable laminate 182 and incorporating an additional component 184. In the embodiment illustrated, the laminate 182 is an outer hydrophobic polymer membrane 186 and an inner fabric 188 with an adhesive 192 between, as shown in FIG. 20A. The hydrophobic polymer membrane 186 and adhesive 192 can be peeled back, as shown in FIG. 20B. In some embodiments, heat or steam can be applied to soften the adhesive to allow the laminate to be fully or partially peeled back. The component 184 can be inserted between the inner fabric 188 and the membrane 186 and adhesive 192, as shown in FIG. 20B. The hydrophobic polymer membrane and adhesive are then placed back over the component and the inner fabric, as shown in FIG. 20C. The adhesive can be reactivatable to adhere the fabric layers once back in place. A hard set fuse, as described above can be applied to the final product to set the adhesives.

Many laminate configurations can be formed with peelable layers including fabrics, adhesives, membrane barrier films and layers, insulation layers, and a variety of embedded products. Any number and/or type of peelable layers can be provided in a laminate. In some embodiments, a laminate can include an outer shell fabric, an adhesive layer, a membrane film, an adhesive layer, and a protective woven or non-woven fabric. In some embodiments, a laminate can include an outer shell fabric, an adhesive layer, and a membrane film provided with a protective abrasion resistant coating.

In some embodiments, a laminate can include an outer shell fabric, adhesive layer, a membrane barrier film, adhesive layer, membrane film, adhesive layer, an inner lining fabric, and an adhesive layer.

In some embodiments, a laminate can include an outer shell fabric, an adhesive layer, a membrane barrier film, an adhesive layer, and an inner lining fabric with or without and an adhesive layer.

In some embodiments, a laminate can include a membrane film, an adhesive layer, a membrane film, and an adhesive layer.

The adhesive layers can be positioned on various surfaces.

In some embodiments, a peelable outer fabric can be provided by positioning an adhesive layer towards the inner surface of the outer fabric or positioning the adhesive layer on one surface of the barrier membrane film.

In some embodiments, a peelable inner fabric can be provided by positioning an adhesive layer towards the inner surface of the inner fabric or positioning the adhesive layer on one surface of the barrier membrane film.

In some embodiments, a peelable outer fabric and inner fabric can be provided by positioning an adhesive layer on both surfaces of a barrier membrane film.

In some embodiments, a peelable component can be provided where an adhesive layer is positioned on the outer surface of the inner fabric.

In some embodiments, a peelable insulation can be provided by positioning and adhesive layer on both surfaces of an insulation layer.

In some embodiments, a process for fabricating a multi-layered fabric product comprises:

(a) providing panels of a peelable laminate in a desired pattern, each panel comprising at least two layers, including at least one fabric layer, a hydrophobic polymer membrane, and an adhesive between the fabric layer and hydrophobic polymer membrane;

(b) peeling back one layer along at least a portion of a perimeter of adjacent panels;

(c) forming at least one seam between adjacent panels along adjacent peeled-back edges;

(d) folding the peeled-back edges back over the at least one seam; and

(e) fusing a plurality of the panels together with a hard set to form a continuous hydrophobic barrier extending across the panels and the at least one seam.

In some embodiments, the process can include in step (c), aligning the adjacent panels with the hydrophobic polymer membrane on an outer surface of the fabric product.

In some embodiments, the process can include in step (c) aligning the adjacent panels with the hydrophobic polymer membrane on an interior surface of the fabric product.

In some embodiments, in step (a), the fabric layer of the laminate can be an outer shell fabric, and the laminate can further include an inner lining fabric, and the hydrophobic polymer membrane can be disposed between the outer shell fabric and the inner lining fabric.

In some embodiments, in step (a), the fabric layer of the laminate can be an outer shell fabric, and the laminate can further include a tricot layer, and the hydrophobic polymer membrane can be disposed between the outer shell fabric and the tricot layer.

In some embodiments, prior to step (b), heat or steam can be applied to reactivate the adhesive to allow the hydrophobic polymer membrane or the at least one fabric layer to be peeled back. In particular, the application of heat or steam softens the adhesive to allow a layer to be peeled back and reactivates the adhesive so that it can be reused when the layer is returned or a new layer is applied.

In some embodiments, in step (a), the laminate can be formed with a soft set at a temperature and pressure that allows the at least one fabric layer or the hydrophobic polymer membrane to be peeled back.

In some embodiments, in step (a), the peelable laminate can be provided in a roll form.

In some embodiments, a process for fabricating a multi-layered fabric product with an embedded component comprises:

(a) providing a panel of a peelable laminate comprising at least two layers, including at least one fabric layer and a hydrophobic polymer membrane, and an adhesive between the fabric layer and hydrophobic polymer membrane;

(b) peeling back at least a portion of one layer;

(c) inserting a component between adjacent layers of the laminate;

(d) folding the peeled-back layer back over the component and the adjacent layer; and

(e) fusing the panel together with a hard set to form a continuous hydrophobic barrier extending across the panel and the component.

The processes disclosed have been described with particularity regarding the fabrication of a jacket. Other products can be fabricated using the processes.

A variety of fabric products can be fabricated by the process as described herein. Such fabric products can include garments or articles of clothing, portions of a garment or an article of clothing, jackets, coats, parkas, raincoats, cloaks, ponchos, shirts, blouses, pants, shoes, boots, gloves, hats, hoods, or other headwear, or underwear such as undershirts, briefs, bras, socks, and diapers. Fabric products can also include protective suits for handling of hazardous materials, including chemicals, biological materials, and radioactive materials, or in protective suits for firefighters, military personnel, and medical personnel. Other fabric products include blankets, towels, sheets, pet bedding, tents, sleeping bags, tarps, boat covers, carpeting, rugs, mats, window coverings, and upholstery, and any fabric-based structure or device that serves to entrap, store, or transport water or an aqueous liquid, such as bags, hoses, or bladders, or where thermal insulation is needed.

Machines to perform the fusion operations are known and commercially available, such as two-dimensional pressing matches and three-dimensional form finishers. As one example, a VEIT 8363 Basic Multiform three-dimensional form finisher is known. A three-dimensional form finisher employs a dummy form over which a fabric product such as a garment is disposed. Heat and steam are introduced through the interior, applying pressure that inflates the garment outwardly and fuses all the layers together. Another example is the Dressman ironing robot from Siemens. To use such a finisher or robot, the garment is placed over the robot, which is then inflated to fit the garment from the inside, applying pressure. The robot is then filled with heated air or steam, which applies heat to the entire garment. For assemblies that lay flat, a two-dimensional pressing machine, such as VEIT BRI-2001 E/101 pressing machine, or another conventional steam ironing table can be used.

Machines for performing cut/weld seaming operations using ultrasound are known and commercially available. For example, the firm Jentschmann, AG (Huntwangen, Switzerland) provides a variety of suitable machines. The ultrasound energy applied during seaming can be adjusted according to the needs of the particular seam, including the characteristics of the fabrics and the adhesive. Welding conditions depend on conditions of temperature and humidity and the type of fabric(s) and hydrostatic polymer membrane. Ultrasonic machines are available which simply weld fabrics together as well as those which cut fabrics in addition to welding them. Adjusting an ultrasonic fabric welding machine according to such conditions is well within the capabilities of the ordinary skilled person. It is understood that an ultrasonic welding or cutting and welding machine can be used to carry out methods in different modes. In addition to ultrasound, other sources of energy that can be used to perform a seam welding operation include heat energy, laser energy, and other forms of electromagnetic radiation (e.g., microwave or radio frequency).

Several known methods are available for testing the hydrostatic resistance properties of a fabric product fabricated as described herein. These include ASTM Standard D 5385, 1993(2014)E1, “Standard Test Method for Hydrostatic Pressure Resistance of Waterproofing Membranes,” ASTM International, West Conshohocken, Pa., DOI: 10.1520/D5385_D5385M-93R14E01. In one example, a fabric product as described herein has a hydrostatic resistance of at least 1, 2, 3, 4, or 5 psi for 3 minutes using ASTM D 5385. In another example, a fabric product as described herein has a hydrostatic resistance of at least 3 psi for 3 minutes using ASTM D 5385. In some embodiments, a fabric product as described herein has a hydrostatic resistance of at least 1, 2, 3, 4, 5, 10, 15, 20, 25, 30, 35, 40, 45, or 50 psi. In some embodiments, a fabric product can maintain a hydrostatic resistance after multiple wash and dry cycles, such as after 5 cycles, 10 cycles, 15 cycles, 20 cycles, 25 cycles, 50 cycles, or 100 cycles. In some embodiments, a fabric product can maintain a hydrostatic resistance after 25 wash and dry cycles of 3 psi for 10 minutes, for 20 minutes, for 30 minutes, or for 60 minutes.

Hydrostatic resistance can also be tested in accordance the Hydrostatic Resistance test method described in ASTM D751, 2006(2011) “Standard Test Methods for Coated Fabrics,” ASTM International, West Conshohocken, Pa., DOI: 10.1520/D0751-06R11. In some embodiments, a fabric product as described herein has a hydrostatic resistance of at least 1, 2, 3, 4, 5, 10, 15, 20, 25, 30, 35, 40, 45, or 50 psi.

The fabric product can also be tested by a test method to evaluate the barrier effectiveness against liquids. Such test methods include ASTM F903, 2010, “Standard Test Method for Resistance of Materials Us in Protective Clothing to Penetration by Liquids,” ASTM International, West Conshohocken, Pa., DOI: 10.1520/F0903-10. The fabric product can be tested as a barrier against various compounds, such as foams (for example, aqueous firefighting foams), hydraulic fluids, battery acid (which includes sulfuric acid, for example, 37%), pool chlorine, and fuels (for example, Fuel C).

As another example, the fabric product can be tested to see if it passes a test for resistance to synthetic blood as determined by ASTM F1670, 2008(2014)E1, “Standard Test Method for Resistance of Materials Used in Protective Clothing to Penetration by Synthetic Blood,” ASTM International, West Conshohocken, Pa., DOI: 10.1520/F1670_F1670M-08R14E01. A further test is to determine if the fabric product passes a test for resistance to pathogenic micro-organisms, including blood borne pathogens as determined by ASTM F1671, 2013, “Standard Test Method for Resistance of Materials Used in Protective Clothing to Penetration by Blood-Borne Pathogens Using Phi-X174 Bacteriophage Penetration as a Test System,” ASTM International, West Conshohocken, Pa., DOI: 10.1520/F1671_F1671M.

As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

It will be appreciated that the various features of the embodiments described herein can be combined in a variety of ways. For example, a feature described in conjunction with one embodiment may be included in another embodiment even if not explicitly described in conjunction with that embodiment.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

The present invention has been described in conjunction with certain preferred embodiments. It is to be understood that the invention is not limited to the exact details of construction, operation, exact materials or embodiments shown and described, and that various modifications, substitutions of equivalents, alterations to the compositions, and other changes to the embodiments disclosed herein will be apparent to one of skill in the art.

What is claimed is:

1. A fabric garment comprising:
a body panel and two sleeve panels, each of the body panels and the two sleeve panels comprising an outer hydrophobic polymer membrane and an inner textile layer fused together over their surfaces;
wherein the two sleeve panels are joined to the body panel along sleeve seams, and the body panel includes a shoulder seam at each sleeve seam;
wherein each of the sleeve seams and the shoulder seams comprises an outer seam comprising joined edge portions of adjacent panels of the hydrophobic polymer membrane and an inner seam comprising joined edge portions of adjacent panels of the inner textile layer, the outer seam and the inner seam adhesively sealed in alignment to form a hydrophobic barrier seam.

2. The fabric garment of claim 1, wherein the body panel comprises a single continuous panel.

3. The fabric garment of claim 1, wherein the body panel has no side seams adjacent the sleeve panels or the body panel extends continuously from one side of a front opening to another side of a front opening.

4. The fabric garment of claim 1, wherein the outer seam is joined by ultrasonic welding.

5. The fabric garment of claim 1, wherein the edge portions of the outer seam are overlapping.

6. The fabric garment of claim 1, wherein the inner seam is joined by ultrasonic welding or sewing.

7. The fabric garment of claim 1, wherein the edge portions of the inner seam are overlapping.

8. The fabric garment of claim 1, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.

9. The fabric garment of claim 1, further comprising an adhesive layer between the outer hydrophobic polymer membrane and the inner textile layer.

10. The fabric garment of claim 1, further comprising a polymer layer coating disposed on an external surface of the hydrophobic polymer membrane, and wherein the polymer coating provides abrasion resistance.

11. The fabric garment of claim 1, further comprising a middle textile layer comprising two middle textile panels joined at a middle seam, the middle seam comprising joined edge portions of each of the two middle textile panels, wherein the middle textile layer is disposed between the membrane and the inner textile layer and the middle seam is disposed between and adhesively sealed in alignment with the outer seam and the inner seam.

12. The fabric garment of claim 1, wherein the inner textile layer comprises a garment shell fabric or a garment lining fabric.

13. The fabric garment of claim 1, further comprising a seam tape adhered between the inner seam and the outer seam within the hydrophobic barrier seam structure, the seam tape comprising a further hydrophobic polymer membrane layer and an adhesive layer on one or both sides of the further hydrophobic polymer membrane layer.

14. A process for fabricating a garment comprising:
(a) providing fabric panels of at least an inner textile layer comprising a body panel and two sleeve panels;
(b) providing membrane panels of at least a hydrophobic polymer membrane corresponding to the body panel and the two sleeve panels;
(c) aligning each membrane panel to a corresponding fabric panel with the hydrophobic polymer membrane on an exterior surface of the inner textile layer, each membrane panel and each corresponding fabric panel laid out flat to form a plurality of composite fabric panels;
(d) fusing each of the composite panels together, leaving an area about a perimeter of each composite fabric panel unfused;
(e) joining the composite panels together at sleeve seams and shoulder seams, each sleeve seam and shoulder seam comprising an outer seam comprising joined edge portions of adjacent panels of the hydrophobic polymer membrane and an inner seam comprising joined edge portions of adjacent panels of the inner textile layer, the outer seam and the inner seam adhesively sealed in alignment to form a hydrophobic barrier seam.

15. The process of claim 14, wherein the body panel is a single continuous panel.

16. The process of claim 14, wherein in step (e), joining the outer seam by ultrasonic welding.

17. The process of claim 14, wherein in step (e), the edge portions of the outer seam are overlapping.

18. The process of claim 14, wherein in step (e), joining the inner seam by ultrasonic welding or sewing.

19. The process of claim 14, wherein in step (e), the edge portions of the inner seam are overlapping.

20. The process of claim 14, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.

21. The process of claim 14, further comprising an adhesive between the outer hydrophobic polymer membrane and the inner textile layer.

22. The process of claim 14, wherein the membrane panel further includes a polymer layer coating disposed on an external surface of the hydrophobic polymer membrane, wherein the polymer coating provides abrasion resistance.

23. The process of claim 14, further comprising joining two middle textile panels at a middle seam to form a middle textile layer, the middle seam comprising joined edge portions of each of the two middle textile panels, wherein the middle textile layer is disposed between the membrane and the inner textile layer and the middle seam is disposed between and adhesively sealed in alignment with the outer seam and the inner seam.

24. The process of claim 14, wherein the inner textile layer comprises a garment shell fabric or a garment lining fabric.

25. The process of claim 14, further comprising, in step (e), inserting a seam tape between the inner seam and the outer seam within the hydrophobic barrier seam structure, the seam tape comprising a further hydrophobic polymer membrane layer and an adhesive layer on one or both sides of the further hydrophobic polymer membrane layer.

26. A multi-layered fabric product containing a hydrophobic barrier seam, comprising:
an outer hydrophobic polymer membrane comprising two membrane panels joined at an outer seam, the outer seam comprising overlapping, adhesively joined edge portions of each of the two membrane panels;
an inner textile layer comprising two textile panels joined at an inner seam, the inner seam comprising overlapping, adhesively joined edge portions of each of the two textile panels;
wherein the outer hydrophobic polymer membrane and the inner textile layer are fused together over their surface areas to provide a laminated product, and the outer seam and the inner seam are in overlapping alignment to form the hydrophobic barrier seam.

27. The product of claim 26, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.

28. The product of claim 26, further comprising an adhesive layer between the outer hydrophobic polymer membrane and the inner textile layer.

29. The product of claim 26, further comprising a polymer layer coating disposed on an external surface of the hydrophobic polymer membrane, wherein the polymer coating provides abrasion resistance.

30. The product of claim 26, further comprising a middle textile layer comprising two middle textile panels joined at a middle seam, the middle seam comprising overlapping, adhesively joined edge portions of each of the two middle textile panels, wherein the middle textile layer is disposed between the membrane and the inner textile layer and the middle seam is disposed between and aligned with the outer seam and the inner seam.

31. A process for fabricating a multi-layered fabric product containing a hydrophobic barrier seam, comprising:
(a) providing membrane panels of an outer hydrophobic polymer membrane and fabric panels of an inner textile layer;
(b) aligning each membrane panel to a corresponding one of the fabric panels to form a plurality of composite panels;
(c) fusing each of the composite panels together, with an area about a perimeter of each composite panel unfused;
(d) interleaving edge portions of the outer hydrophobic polymer membrane and the inner textile layer along the unfused perimeters of two adjacent composite panels; and
(e) fusing a plurality of the composite panels together to form the hydrophobic barrier seam along the interleaved edge portions and to form a continuous hydrophobic barrier across the adjacent composite panels extending over the hydrophobic barrier seam.

32. The process of claim 31, wherein the outer hydrophobic polymer membrane comprises microporous or nanoporous polytetrafluoroethylene, expanded polytetrafluoroethylene, polyurethane, cross-linked polyurethane, polypropylene, polyester, or a waterproof nonporous polymer film.

33. The process of claim 31, further comprising providing an adhesive between the outer hydrophobic polymer membrane and the inner textile layer.

34. The process of claim 31, further comprising providing a polymer layer coating disposed on an external surface of the outer hydrophilic polymer membrane, wherein the polymer layer coating provides abrasion resistance.

35. The process of claim 31, further comprising providing a middle layer comprising two middle textile panels joined at a middle seam, the middle seam comprising overlapping, adhesively joined edge portions of each of the two middle textile panels, wherein the middle textile layer is disposed between the membrane and the inner textile layer and the middle seam is disposed between and aligned with the outer seam and the inner seam.

36. A process for fabricating a multi-layered fabric product comprising:
(a) providing fabric panels of a peelable laminate comprising at least two layers, including at least one fabric layer, a hydrophobic polymer membrane, and an adhesive between the fabric layer and hydrophobic polymer membrane;
(b) peeling back one layer along at least a portion of a perimeter of adjacent fabric panels;
(c) forming at least one seam between adjacent fabric panels along adjacent peeled-back edges;
(d) folding the peeled-back edges back over the at least one seam; and
(e) fusing a plurality of the fabric panels together with a hard set to form a continuous hydrophobic barrier extending across the fabric panels and the at least one seam.

37. The process of claim 36, further comprising in step (c), aligning the adjacent fabric panels with the hydrophobic polymer membrane on an outer surface or an interior surface of the fabric product.

38. The process of claim 36, wherein in step (a), the fabric layer of the laminate is an outer shell fabric, and the laminate further includes an inner lining fabric, and the hydrophobic polymer membrane is disposed between the outer shell fabric and the inner lining fabric.

39. The process of claim 36, wherein, in step (a), the laminate is formed with a soft set at a temperature and pressure that allows the at least one fabric layer or the hydrophobic polymer membrane to be peeled back.

40. A process for fabricating a multi-layered fabric product comprising:
(a) providing fabric panels of a peelable laminate comprising at least two layers, including at least one fabric layer, a hydrophobic polymer membrane, and an adhesive between the fabric layer and hydrophobic polymer membrane;
(b) peeling back one layer along at least a portion of a perimeter of adjacent fabric panels;
(c) inserting a component into the laminate where the at least one layer is peeled back;
(d) folding the peeled-back edges back to reform the laminate; and
(e) fusing a plurality of the fabric panels together with a hard set to form a continuous hydrophobic barrier extending across the fabric panels and the at least one component.

41. The process of claim 40, wherein the component comprises one or more of electrical circuitry, an electrical component, an impact resistant component, and a medical component.

42. A process for fabricating a multi-layered fabric product comprising:
(a) providing fabric panels of a peelable laminate comprising at least three layers, including at least two fabric layers, a hydrophobic polymer membrane, and an adhesive between the fabric layer and hydrophobic polymer membrane;
(b) peeling back at least one layer;
(c) removing one of the fabric layers from the laminate where the at least one layer is peeled back;
(d) reforming the laminate; and
(e) fusing a plurality of the fabric panels together with a hard set to form a continuous hydrophobic barrier extending across the fabric panels.
